(19) United States
(12) Patent Application Publication
(10) Pub. No.: US 2024/0185340 A1
(43) Pub. Date: Jun. 6, 2024

(54) SYSTEMS, DEVICES, AND METHODS FOR A DECENTRALIZED FINANCE PLATFORM FOR DIGITAL TOKENS

(71) Applicants: Sergio Samir Solano, Barranquilla (CO); Daniel Dragan Konjevic, Richmond Hill (CA)

(72) Inventors: Sergio Samir Solano, Barranquilla (CO); Daniel Dragan Konjevic, Richmond Hill (CA)

(21) Appl. No.: 18/072,955

(22) Filed: Dec. 1, 2022

(51) Int. Cl. G06Q 40/04; G06Q 20/06; G06Q 20/38; G06Q 40/03

(52) U.S. Cl. CPC G06Q 40/04; G06Q 20/065; G06Q 20/389; G06Q 40/03

(57) ABSTRACT

A computer-implemented system and method for regulating a finance platform on a blockchain network by selling, via at least one coin offering, at least a portion of token not in circulation at a pre-determined price; storing at least a portion of a stable coin in a treasury, each portion of stable coin received from sale of token not in circulation via the at least one coin offering; and removing at least a portion of token from circulation to regulate a floor price of each token, the floor price being: (total stable coin stored in the treasury+total stable coin loaned)/(total token in circulation). At least one token can be removed from the circulation by charging at least one fee in token currency. A stable coin can be loaned with a token as collateral, the token being taken out of circulation on loan default.

### FIELD

The present specification relates generally to finance platforms, and, more specifically, to finance platforms involving digital tokens.

### BACKGROUND

Blockchain technology can provide a decentralized public record. Data can be stored in blocks that are linked together in a chain. The stock market and cryptocurrency markets can experience significant fluctuations in the value of the securities traded. The value of these securities can depend solely on market pressures.

### SUMMARY

In accordance with an aspect, a system for a finance platform includes: at least one stored data structure defining: one or more treasury smart contracts configured to: sell, via at least one coin offering, at least a portion of token not in the circulation at a pre-determined price; store at least a portion of a stable coin in a treasury, each portion of stable coin received from sale of the at least a portion of token not in circulation via the at least one coin offering; and remove at least a portion of token from the circulation to regulate a floor price of each token, the floor price being: (total stable coin stored in the treasury+total stable coin loaned)/(total token in the circulation). The system further includes at least one processor configured to execute at least one of: the one or more treasury smart contracts, the one or more exchange smart contracts, or both.

In some embodiments, the pre-determined price is twice the floor price and a number of tokens sold being set to increase the floor price by a pre-determined amount.

In some embodiments, the pre-determined amount is 1%.

In some embodiments, the system further includes a token regulator configured to remove at least a portion of token from the circulation by charging at least one fee in token currency.

In some embodiments, each fee includes a loan fee, a transfer fee, an exchange fee, or any combination thereof.

In some embodiments, the system further includes a stable coin loaner configured to: loan at least a portion of the stable coin from the treasury in exchange for at least a portion of token each at the floor price as a token collateral; and if a loan is in default, remove at least a portion of token collateral from the circulation.

In some embodiments, each stored data structure is stored on a blockchain network.

In some embodiments, the one or more treasury smart contracts is configured to remove token from the circulation by purchase.

In some embodiments, the at least one stored data structure defines one or more exchange smart contracts configured to manage token transactions between two or more users.

In some embodiments, the system further includes a token regulator configured to charging a trading license fee in stable coin currency and issue a portion of the trading license fee to a user and remove token from circulation by purchasing token using a second portion of the fee.

In accordance with an aspect, a computer-implemented method for regulating a finance platform on a blockchain network includes: selling, via at least one coin offering, at least a portion of token not in the circulation at a pre-determined price; storing at least a portion of a stable coin in a treasury, each portion of stable coin received from sale of the at least a portion of token not in circulation via the at least one coin offering; and removing at least a portion of token from the circulation to regulate a floor price of each token, the floor price being: (total stable coin stored in the treasury+total stable coin loaned)/(total token in the circulation).

In some embodiments, the pre-determined price is twice the floor price and a number of tokens sold is set to increase the floor price by a pre-determined amount.

In some embodiments, the pre-determined amount is 1%.

In some embodiments, the method further includes removing at least a portion of token from the circulation by charging at least one fee in token currency.

In some embodiments, each fee includes a loan fee, a transfer fee, an exchange fee, or any combination thereof.

In some embodiments, the method further includes loaning at least a portion of the stable coin from the treasury in exchange for at least a portion of token each at the floor price as a token collateral; and if a loan is in default, removing at least a portion of token collateral from the circulation.

In some embodiments, the one or more treasury smart contracts are configured to remove token from the circulation by purchase.

In some embodiments, the at least one stored data structure defines one or more exchange smart contracts configured to manage token transactions between two or more users.

In some embodiments, the method further includes charging a trading license fee in stable coin currency and issuing a portion of the trading license fee to a user and removing token from circulation by purchasing token using a second portion of the fee.

In accordance with an aspect, a non-transitory computer-readable medium storing a set of machine-interpretable instructions, which, when executed, cause a processor to perform a method for regulating a finance platform, is provided. The method includes: selling, via at least one coin offering, at least a portion of token not in the circulation at a pre-determined price; storing at least a portion of a stable coin in a treasury, each portion of stable coin received from sale of the at least a portion of token not in circulation via the at least one coin offering; and removing at least a portion of token from the circulation to regulate a floor price of each token, the floor price being: (total stable coin stored in the treasury+total stable coin loaned)/(total token in the circulation).

In accordance with an aspect, a computer-implemented method for regulating a finance platform on a blockchain network includes storing a stable coin in a treasury, using treasury smart contracts, each stable coin received from sale of at least one token not in circulation via at least one coin offering, and removing at least one token from the circulation to regulate a floor price of each token, the floor price being: (total stable coin stored in the treasury+total stable coin loaned)/(total token in the circulation); and selling, using one or more exchange smart contracts, via the at least one coin offering, the at least one token not in the circulation at a pre-determined price. At least one token can be removed from the circulation by charging at least one fee in token currency. A stable coin can be loaned with a token as collateral, the token being taken out of circulation on loan default.

Other aspects and features and combinations thereof concerning embodiments described herein will become apparent to those ordinarily skilled in the art upon review of the instant disclosure of embodiments in conjunction with the accompanying figures.

### DESCRIPTION OF THE DRAWINGS

Embodiments may better be understood with reference to the accompanying figures provided by way of illustration of an exemplary embodiment, or embodiments, and in which:

FIGS. 1A and 1B are schematic views of a finance platform, according to some embodiments;

FIG. 2 is a schematic view of a finance platform, according to some embodiments; and

FIG. 3 is a schematic view of a finance platform, according to some embodiments.

### DETAILED DESCRIPTION

The description that follows, and the embodiments described therein, are provided by way of illustration of an example, or examples, of particular embodiments. These examples are provided for the purposes of explanation, and not of limitation. In the description, like parts are marked throughout the specification and the drawings with the same respective reference numerals. The drawings are not necessarily to scale and in some instances proportions may have been exaggerated in order to more clearly to depict certain features.

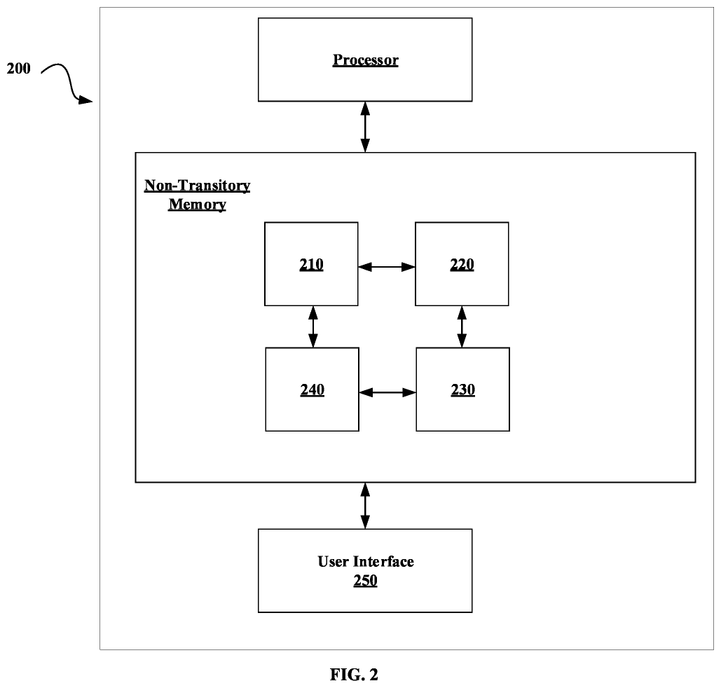

FIG. 2 shows an example finance platform 200, according to some embodiments. In some embodiments, finance platform 200 includes a processor configured to execute instructions in non-transitory memory to configure in non-transitory memory, various components of finance platform 200, including a treasury smart contract manager 210, an exchange smart contract manager 220, a token regulator 230, and/or a stable coin loaner 240. In some embodiments, stable coin loaner 240 and/or token regulator 230 are not included in finance platform 200. In some embodiments, finance platform 200 transmits data to and/or from user interface 250 and configures a display at user interface 250 and receives data input from a user. In some embodiments, finance platform 200 is configured to reduce negative volatility and provide a technologically-ensured mechanism for creating stable growth of token value.

In some embodiments, treasury smart contract manager 210 is configured to manage at least one stored data structure defining the one or more treasury smart contracts. For example, one or more processors are configured to execute the one or more treasury smart contracts. Such execution can be performed over a distributed network or blockchain. A smart contract comprises computer-interpretable instructions which, when executed, cause a processor to perform the features of the smart contract.

In some embodiments, exchange smart contract manager 220 is configured to manage at least one stored data structure defining the one or more exchange smart contracts. For example, one or more processors are configured to execute the one or more exchange smart contracts. Such execution can be performed over a distributed network or blockchain.

In some embodiments, each stored data structure is stored on a blockchain network. In some embodiments, each smart contract is stored on a blockchain network. This can facilitate creation of a public, transparent, immutable record of transactions and value. For example, the blockchain network can be Binance Smart Chain (BEP-20).

In some embodiments, finance platform 200 includes at least one stored data structure defining one or more treasury smart contracts configured to store at least a portion of a stable coin in a treasury, each portion of the stable coin received from sale of at least one token not in circulation via at least one coin offering. In some embodiments, more stable coin is brought into the treasury (e.g., via coin offerings) than tokens are in circulation, and treasury smart contract(s) and exchange smart contract(s) are configured to interoperate to regulate this balance and the floor price of tokens. As used herein, a stable coin can refer to a portion of a stable coin. In some embodiments, a token can be sold in fractions (i.e., portion) of tokens that is subject to price. For example, as the token price grows, a fraction of a token can be purchased. For example, blockchain can be calculated and specified at 18 decimal places. As an example, there can be set a limit of 15 BUSD for purchasing token.

Treasury smart contract manager 210 is configured to manage and/or execute treasury smart contracts. The one or more treasury smart contracts are further configured to remove at least a portion of token from the circulation to regulate a floor price of each token. The floor price of token in circulation is defined by (total stable coin stored in the treasury+total stable coin loaned)/(total token in the circulation). For example, to store a stable coin in a treasury, treasury smart contract manager 210 is configured to update an attribute (e.g., ownership) of stable coin on the blockchain, such as to update an ownership attribute from the user (the user purchasing a token offered in a coin offering in exchange for the stable coin) to represent storage in the treasury and not owned by any user (or, in some embodiments, co-owned pro-rated to the users' holdings of token). For greater clarity, in some embodiments, an attribute is updated to represent what entity (e.g., user, treasury) has token and/or stable coin, where same came from, and where same is being transferred to. For example, each token or stable coin can be generic, with only quantities rather than specific identities (or rather than specific attributes of a specific stable coin or token) being tracked. In some embodiments, for example, treasury smart contract manager 210 is configured to remove from circulation a token or fraction of token for a specific action that involves fees (e.g., exchange fees, interest fees, transfer fees).

Transfer, collection, removal from circulation, sale, purchase, providing into circulation, and/or other actions relating to a stable coin and/or a token can be implemented similarly, with corresponding attributes relating to stable coin and/or token and/or accounts and/or treasuries or aggregations of same being updated to define the action (e.g., transfer of ownership). In some embodiments, removal from circulation of a token or a stable coin can be directed to separate treasuries. In some embodiments, a treasury as used herein can refer to a token treasury, a token collateral treasury, or a stable coin treasury. The token treasury can receive tokens removed from circulation upon purchase or buyback of token or collection of fees such as by treasury smart contract manager 210, for example. The token collateral treasury can receive tokens held as collateral for loans (e.g., of stable coin) issued by stable coin loaner 240. Stable coin treasury can receive stable coins upon sale of token, such as via a coin offering by treasury smart contract manager 210, for example.

In some embodiments, a separate treasury smart contract is configured to manage and/or define each of these separate treasuries. For example, in some embodiments, there is a treasury smart contract (also referred to as token treasury smart contract) corresponding to token treasury, a treasury smart contract (also referred to as token collateral treasury smart contract) corresponding to token collateral treasury (managed by stable coin loaner 240), and a treasury smart contract (also referred to as stable coin treasury smart contract) corresponding to stable coin treasury, each defining the functions corresponding to each as described herein.

For example, according to some embodiments, token treasury smart contract defines and facilitates management and implementation of coin offerings and receipt of all fees levied or received in token currency. Token regulator 230 can be configured to interoperate with token treasury smart contract to facilitate same, for example, by implementing at least a portion of the token treasury smart contract.

As another example, according to some embodiments, stable coin treasury smart contract defines and facilitates management of stable coin from coin offerings, buybacks, and/or a trading license smart contract that directs a portion (e.g., 50%) of trading license fees to the stable coin treasury. Token regulator 230 can be configured to interoperate with stable coin treasury smart contract to facilitate same, such as by implementing at least a portion of stable coin treasury smart contract. For example, stable coin treasury smart contract is configured to direct the flow of stable coin into and out of stable coin treasury.

In some embodiments, token collateral treasury smart contract defines and facilitates management of stable coin loans. Stable coin loaner 240 can be configured to interoperate with token collateral treasury smart contract to facilitate same. For example, in some embodiments, stable coin loaner 240 is configured to implement at least a portion of token collateral treasury smart contract to define collection of loan fees and/or interest payments. Token regulator 230 can be configured to interoperate with stable coin treasury smart contract to facilitate fee collection in relation to loans.

In some embodiments, token regulator 230 is configured to implement at least a portion of the respective smart contracts to implement the respective functions described herein.

Tokens removed from circulation (e.g., an attribute of a treasury representing a quantity of token stored therein) can be re-issued into circulation via purchase through a coin offering.

In some embodiments, the one or more treasury smart contracts are configured to remove the at least a portion of a token from the circulation by purchase. For example, this token removed from circulation can refer to a token (or portion thereof) that was purchased and was in circulation, where its removal from circulation is due to collection of a fee, and the recipient of the fee is the token treasury, which controls circulation. Tokens taken out of circulation can be resold through a future coin offering. In some embodiments, after a coin offering is complete, a new coin offering is generated. In some embodiments, a treasury smart contract is configured to sell coin offerings and also receive tokens that are taken out of circulation, such as for storage in the token treasury.

In some embodiments, at least one stored data structure defines one or more treasury smart contracts configured to sell, via the at least one coin offering, the at least one token not in the circulation at a pre-determined price. In some embodiments, the pre-determined price is twice the floor price and a number of tokens sold being set to increase the floor price by a pre-determined amount. For example, the pre-determined amount can be 1%. For example, treasury smart contract, when executed by one or more processors, is configured to propagate a request for sale and/or receive requests for purchase of one or more tokens. A user, such as engaged at finance platform 200 via a user interface (e.g., at a mobile device or computer), can provide user input to request purchase of a number of tokens. Treasury smart contract manager 210 is configured to regulate the number of tokens sold and the price that same are sold at in a present coin offering, as well as in subsequent coin offerings. The number and price can be set and/or dynamically updated in real time so as to increase the floor price of tokens. This can help prevent a drop in token value by virtue of the finance platform 200 computer architecture and its defined smart contracts, according to some embodiments.

In some embodiments, a coin offering is defined as follows:

z=(−ad+c)/(a−b)

y=z*2%

x=z+y,
where:
a=Trigger price (defined as b*50.5%)
b=Initial cap (defined as 2× of initial floor price)
c=Initial stable coin treasury
d=Initial circulating supply
z=tokens in coin offering prior to fees
y=2% of z, with y being a fee
x=sum of token in coin offering and 2% fee

The coin offering variables are dynamically updated as the circulating supply and stable coin in the stable coin treasury increase or decrease. x can result in 0 without any tokens being purchased from the coin offering. When x=0 or less than a threshold number, the coin offering automatically closes. A new coin offering is created at two times the current floor price and the treasury smart contract manager 210 is configured to determine the number of tokens to be sold in the new coin offering using the coin offering definition as shown in the foregoing. In some embodiments, numbers other than those shown in the foregoing formula can be used, for example, the percentage in the formula for y, the number shown in the trigger price, or the number shown in the cap price.

In some embodiments, treasury smart contract manager 210 is configured to execute a treasury smart contract (e.g., token treasury smart contract) defining a subsequent coin offering as follows.

### Known Variables for Formula 2:

2's Initial Cap=1's Trigger price*2
a=Trigger price
b=Initial Cap
c=(Initial stable coin treasury+1's $/Cap Ad)
d=(Initial Circulating Supply+1's Number of Coins/Tokens)

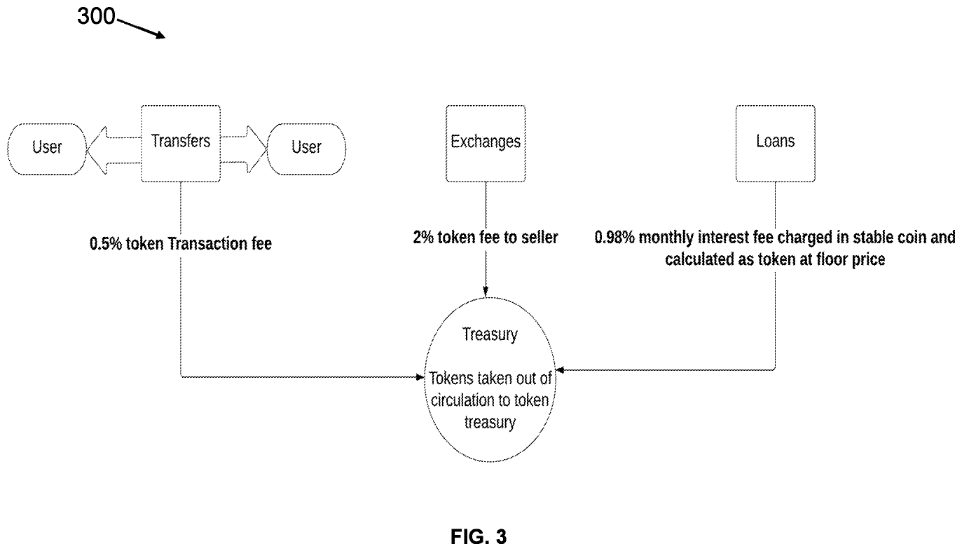

Exchange smart contract manager 220 is configured to manage and/or execute exchange smart contracts. In some embodiments, only one exchange smart contract is used. An exchange smart contract defines and regulates user transactions, including user offers (bids and asks) for purchase and/or sale of token, for example. The exchange smart contract can allow for offer prices up to the token treasury price (sold via a coin offering) or down to the stable coin treasury price (set as the floor price). FIG. 3 is a schematic diagram of an example user transaction defined by the exchange smart contract. As shown, transaction fees in token currency can be collected in some embodiments. A treasury smart contract can define the fee(s) to be collected and direct same to the token treasury, out of circulation, according to some embodiments.

In some embodiments, at least one stored data structure defines one or more exchange smart contracts. For example, exchange smart contract, when executed by one or more processors, is configured to propagate a request for sale and/or receive requests for purchase of one or more tokens from users. A user, such as engaged at finance platform 200 via a user interface (e.g., at a mobile device or computer), can provide user input to request purchase of a number of tokens. According to some embodiments, an exchange smart contract is configured for managing and defining purchase and sale of tokens between users and/or sale by users of token collateral held in the token collateral treasury.

In some embodiments, the exchange smart contract defines and levies a fee on a purchaser of token. For example, this fee can be 2% of the transaction amount and levied in stable coin currency, and the exchange smart contract is configured to direct the fee to an entity (e.g., a company-controlled wallet). In some embodiments, the exchange smart contract also, or alternatively, defines and levies a fee on the seller of the token(s) in token currency, which is then directed to the token treasury, out of circulation. If the seller is the token treasury (e.g., such as in a coin offering as managed by treasury smart contract), this fee is retained by the token treasury.

Finance platform 200 further includes at least one processor configured to execute at least one of: the one or more treasury smart contracts, the one or more exchange smart contracts, or both. In some embodiments, finance platform 200 further includes other smart contracts executed by at least one processor, for example, a buyback smart contract.

In some embodiments, finance platform 200 includes a token smart contract, which mints token. This token is stored in the token treasury and used to create coin offerings, bringing tokens into circulation. In some embodiments, token smart contract is included in a treasury smart contract, such as a token treasury smart contract.

In some embodiments, stable coin treasury smart contract defines and manages all stable coin funds generated from coin offerings and received from trading license fees (e.g., 50% of the trading license fee is returned to stable coin treasury by stable coin treasury smart contract). Stable coin treasury smart contract is configured to define the management of funds in (and flow in/out of) the stable coin treasury to facilitate maintenance and management of the floor price of token.

In some embodiments, token collateral treasury smart contract defines and manages token held as collateral for loans issued from the stable coin treasury. Interest from loans are charged in token currency and taken out of circulation, which can increase the floor price.

In some embodiments, finance platform 200 includes token floor price smart contract (which can be included in a token treasury smart contract), which defines the floor price according to the definition provided herein, including dividing the stable coin in the stable coin treasury by the circulating supply of token.

In some embodiments, finance platform 200 includes a token exchange, defined in part by smart contracts as follows. A token exchange smart contract (or exchange smart contract) defines a decentralized P2P exchange. An exchange fee (e.g., 2%) is charged in token and removed from circulation, which can increase the floor price of token. A token treasury (exchange cap) smart contract is configured to generate coin offerings. Until purchased, these tokens are not part of circulation. Once purchased, the stable coin received in the sale is sent to the stable coin treasury, which can increase the floor price of token. A token trading license smart contract is configured to direct the receipt of funds from a trading license fee. For example, 50% can be issued to the referrer and 50% directly to the stable coin treasury, which can increase the floor price. In some embodiments, a buyback smart contract can use stable coin so directed into the treasury to purchase token and remove same from circulation. In some embodiments, where a token trading license smart contract is included in finance platform 200, token membership and buyback smart contracts are not included.

A token governance smart contract allows smart contracts to be migrated or included. This can be a community governed protocol, where every shareholder or defined user can vote.

In some embodiments, finance platform 200 includes token registrar smart contract, which defines all token smart contracts and is configured to swap contracts in and out, such as if not finalized (e.g., as during setup by an administrator user). If token registrar smart contract is finalized, it provides a record of the token smart contracts.

In some embodiments, finance platform 200 includes a token regulator 230 configured to remove at least one token from the circulation by charging at least one fee in token currency. Example fees include a loan fee, transfer fee, an exchange fee, or any combination thereof. A trading license fee can be levied in stable coin currency. A trading license fee can be used to facilitate a buyback, in some embodiments. In some embodiments, buyback is not included. A fee can be levied on a user's (or users') account(s) to reduce a number of tokens corresponding to the fee amount and transfer the tokens out of circulation, such as into a treasury. A loan fee can be levied in respect of interest amounts on a loan. For example, in some embodiments, this can be when interest amounts on the loan are due. As another example, in some embodiments, a loan fee is only accrued daily but not paid until a user initiates one of three methods of payback. This is required because the user initiates payment of a gas fee to miners to transfer the interest from the collateral loan treasury (e.g., token collateral treasury) to the token treasury. The three methods of payment comprise direct repayment, creation of a collateral offer with the user's collateral (ask), or responding to an existing offer (bids). Stable coin loaner 240 is configured to receive and/or request such payments from users, corresponding to recorded loans issued. Token collateral treasury smart contract is configured to define these functions and manage token collateral treasury. For example, token collateral treasury is configured to receive and manage interest fees (e.g., charged in token currency and taken out of circulation to the token treasury), origination fees (e.g., 0.5% that goes to a company controlled account; this is charged in stable coin), extension fees (e.g., 0.5% fee when a user wants to extend their loan; this is charged in stable coin and goes to the company controlled account), and/or other fees.

A transaction fee can be levied when transactions are performed between users (e.g., to transfer tokens from one user to another). An exchange fee can be levied when pre-determined actions or events occur, such as from purchases or sales as managed by the exchange smart contract. Token regulator 230 is configured to direct proceeds from a trading license fee to a referring user (or entity) and as a donation to the stable coin treasury, increasing the floor price of token. For example, in some embodiments, the split can be 50/50. When stable coin goes into the stable coin treasury, it does not go out of circulation, according to some embodiments. In some embodiments, the trading license fee is collected from users, in exchange for an update to the user(s)′ permissions to use user the exchange process (e.g., buying or selling from users, the token treasury (for buying) or stable coin treasury (for selling)). The trading license fee is paid by the user, and 50% of the fee goes to the referrer and 50% is directly deposited to the stable coin treasury, according to some embodiments.

In some embodiments, the proceeds from the trading license fee are directed to a number of tiers and percentage also to a buyback smart contract.

In some embodiments, instead of a buyback smart contract or multi-referral system, there is a trading license smart contract configured to direct proceeds to a simple one-level referral system (e.g., directed to a user) and to a direct donation or deposit of stable coin to the stable coin treasury. In the trading license system, when a user pays the trading license fee, the referrer gets 50% of the trading license fee and the other 50% is deposited to the stable coin treasury directly. No tokens are involved in this transaction, according to some embodiments.

Tokens taken out of circulation can be represented in a treasury (having an associated attribute updated to denote same) and the tokens can be sold through a subsequent coin offering, for example. Token regulator 230 is configured to update attribute(s) associated with the ownership and/or possession of the token(s) as same are removed from circulation, levied as fee(s), transferred to a treasury, and/or bought back from a user(s). The attribute(s) are updated to represent the outcome of the transaction and/or action, for example. For example, a user account or wallet can have an attribute denoting the number of tokens held. As another example, a token treasury can have an attribute denoting the number of tokens held. As another example, a stable coin treasury can have an attribute denoting the number of stable coins held. As another example, a token collateral treasury can have an attribute denoting the number of tokens held and for which user(s)/entit(ies)/loan(s) same are held for.

In some embodiments, the token regulator 230 is configured to issue a portion of the at least one fee to a user. The user(s) to receive the portion of the fee can be selected by token regulator based on criteria, such as to reward user(s) for referrals.

In some embodiments, the token regulator 230 is configured to issue a portion of the at least one fee to a user and remove a second portion of the at least one fee from the circulation. For example, some of the token(s) levied as part of a transaction fee can be assigned to another user as a community reward, while some of the token(s) levied can be removed from circulation and assigned to a treasury, where the token(s) can later be re-issued back to circulation in a subsequent coin offering. For example, a user can purchase a trading license (e.g., to enable that user to then purchase or sell tokens via exchange smart contract) such as in stable coin currency, and proceeds from that purchase of the trading license is distributed, such as across five levels, one of which is reserved for a buyback smart contract to purchase tokens in circulation. In some embodiments, buyback smart contract is not included. Buyback smart contract is configured to purchase the lowest price possible of token and remove those tokens from circulation. For example, if the tokens from purchased from token treasury (via a treasury smart contract that offers coin offerings from token treasury), the purchased tokens come in and back out while the stable coin is directed to the stable coin treasury. As another example, tokens directed for purchase by the buyback smart contract can be purchased via tokens offered via the exchange smart contract. In some embodiments, for example, the buyback smart contract receives a portion of the trading license fee (e.g., 10%) such as from a token membership contract. The buyback smart contract can be stored in a data structure and executed by one or more of the processors. The buyback smart contract is configured to define purchase of token from a user offer or from the token treasury itself (e.g., whichever is the lowest price) and take that token out of circulation. The stable coin is exchanged with the user (if it was a user offer) or the stable coin treasury if it was the token treasury that the token was purchased from (e.g., via a coin offering). If the purchase was from the token treasury, the token is transferred to the buyback and back to the token treasury in one transaction having a net zero effeet for token, but BUSD is directed for deposit to the stable coin treasury, according to some embodiments. A buyback smart contract can be included in a treasury smart contract, according to some embodiments.

In some embodiments, a buyback is performed only following collection of a trading license fee. A trading license fee is directed to a token membership smart contract, which allocates 90% across a number of tiers (e.g., 5, such as for community reward, for example) and 10% is allocated for use by the buyback smart contract to purchase token such as at the lowest offer and removes the purchased tokens from circulation. The stable coin is directed to the user (if the purchase was from a user offer) or to the stable coin treasury (if the purchase was from a coin offering from the token treasury).

In some embodiments, token regulator 230 is configured to implement a token exchange floor smart contract, which defines, sets, and determines the floor price of token. For example, token exchange floor smart contract sets the floor price according to the formula described herein, according to some embodiments. A 2% token/stable coin is calculated and executed for all trades, including on any contract where token/stable coin may be traded. This includes for: token treasury (token exchange cap), token exchange (user), token floor exchange, and token collateral loan. Stable coin loaner 240 implementing token collateral treasury smart contract is configured to define, collect, and direct funds arising from loans and its associated fees and interest (interest fees, origination fees, extension fees, etc.). According to some embodiments, a peer-to-peer fee is managed and defined by a token smart contract, which is the original minter contract of token. The token smart contract can only mint to the token treasury, in some embodiments.

In some embodiments, finance platform 200 includes a stable coin loaner 240 configured to loan at least one of the stable coin from the treasury in exchange for at least one token each at the floor price as a token collateral; and if a loan is in default, remove at least one token collateral from the circulation. Stable coin loaner 240 is also configured to update an attribute representing the number of stable coin loaned out and in circulation.

An example embodiment will now be described. In some embodiments, there is provided a decentralized financial software platform built on the Binance Smart Chain blockchain or other suitable blockchain, where the platform minimizes the negative volatility associated with the crypto and traditional stock markets by using smart contracts to regulate the price of the proposed technology's token, so that it does not fall below the “floor price,” a price set by the platform, as well as allows the floor price to continuously increase so as to guarantee a return. The floor price is defined as (stable coin in the treasury+loaned out stable coin)/token in circulation. The token in circulation can be defined as (total collateralized token+total free token), for example. In some embodiments, token prices are prevented from falling below the floor price, according to some embodiments. For example, stable coin held in the stable coin treasury (and the platform's direction and management of stable coin into same) and treasury smart contract manager 210 and exchange smart contract manager 220 are configured to facilitate same. A stable coin treasury smart contract implements a treasury by creating the floor price by storing the stable coin (e.g., BUSD (Binance USD)), which is accumulated from the sale of token via coin offerings and, in some embodiments, from trading license fees. For example, in some embodiments, a portion (e.g., half) of fees collected as trading license fees are directed to the stable coin treasury, thereby benefiting the floor price of token. In some embodiments, a buyback smart contract is configured to buy back token in circulation so as to create/increase the floor price and create demand for token. In some embodiments, buyback smart contract is configured to use token collected by a token membership smart contract (or a source of token not in circulation) and purchase tokens available via the exchange smart contract or via a coin offering (as managed by a token treasury smart contract). The token(s) purchased by buyback smart contract is directed to the token treasury, out of circulation.

In this example embodiment, a token treasury smart contract is configured to regulate the purchase price of tokens not in circulation via coin offerings, which allow users to purchase tokens that are not in circulation at the coin offerings price using stable coin and thereby bring the token into circulation. The coin offerings price is set at twice the price of the floor price and the number of token offered at that price is set so as to increase the floor price by 1% once that coin offering is completed. In some embodiments, other amount (e.g., percentage) increases are possible or set. A subsequent coin offering is available after a previous coin offering is completed. Accordingly, typically, the price of token should tend to not be a massive multiple of the floor price. The platform charges fees (including for loans) in token currency, which takes the token out of circulation and allows same to be resold at a higher price via the token treasury smart contract. This also removes token from circulation and increases the floor price. In some embodiments, an exchange smart contract defines and levies a fee on a purchaser of token. For example, this fee can be 2% of the transaction amount and levied in stable coin currency, and the exchange smart contract is configured to direct the fee to an entity (e.g., a company controlled wallet). In some embodiments, the exchange smart contract also, or alternatively, defines and levies a fee on the seller of the token(s) in token currency, which is then directed to the token treasury, out of circulation. If the seller is the token treasury (e.g., such as in a coin offering as managed by treasury smart contract), this fee is retained by the token treasury.

In this example embodiment, the platform is configured to charge at least some fees in token currency and the fees are taken out of circulation, which increases the floor price. For example, loan interest can be determined in stable coin currency or a dollar amount and when the interest is paid it can be calculated at the present floor price of token and that amount of token is levied and taken out of circulation. As another example, for exchange fees and transaction or transfer fees, the fee can be calculated as a a direct percentage of the token itself.

A user can send token to other user(s), and the platform is configured to charge a fee in token currency, and the fee in token currency is taken out of circulation. In this example embodiment, community rewards and buyback are generated from trading license fees. For example, these fees can be split as 90% in community rewards and 10% in buyback. Other splits can be used. The community rewards can be up to five levels but each level can have unlimited number of people. This provides a reward for referrals. In a buyback, token is purchased and taken out of circulation, creating demand for the token. In some embodiments, a trading license fee levied by token regulator 230 directs 50% to the referrer and 50% to the stable coin treasury.

In this example embodiment, the platform is configured to implement collateral loans to users. Users can take out loans in stable coin from the treasury by using tokens, at the floor price, as collateral. This can facilitate loans that come with low to zero risk of liquidation and/or are crash-proof. Otherwise, if portions of the collateralized coins are sold as the market price decreases, if there is a significant decrease in the market, the complete loss of collateral can result. For example, tokens can be sold by other collateral holders as the collateral drops in value to ensure the collateral holder will receive the loan amount+any fees. Instead, since the collateral as implemented by the platform is at the floor price, which the platform prevents from decreasing according to some embodiments, if a user ends up defaulting on their loan, their coins (tokens) are simply taken out of circulation. Users of the platform can sell their token collateral and receive pro-rated amounts of stable coin from the sale. The price movement of token held as collateral is never at risk of being sold by the collateral holder (the token collateral treasury) as the floor price cannot go down.

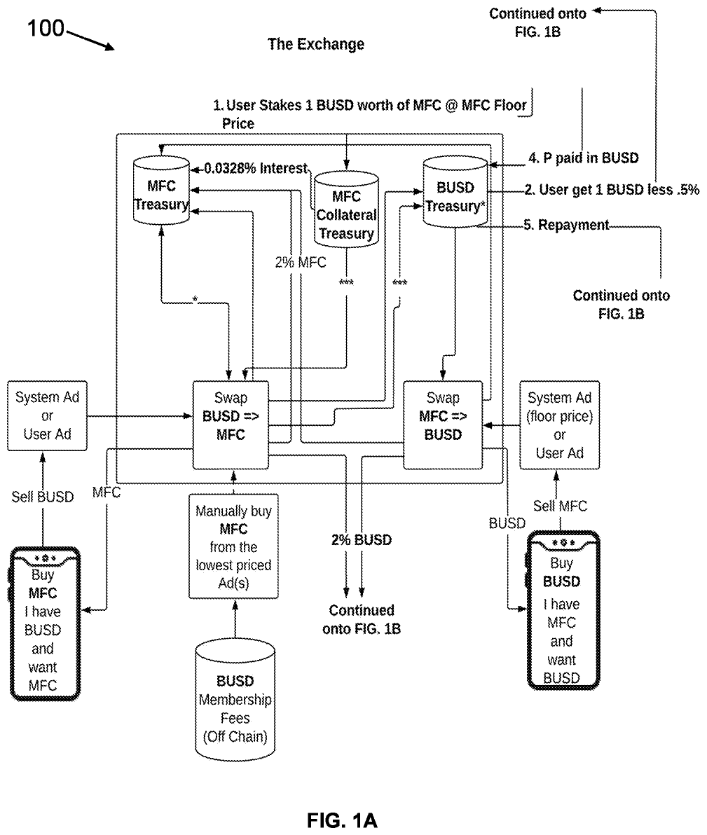

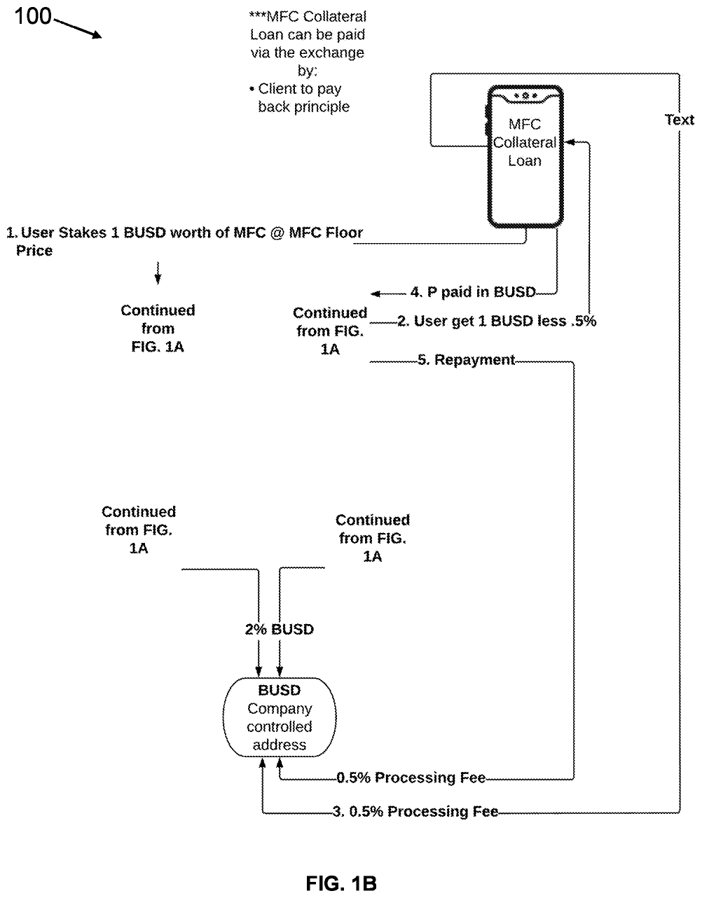

FIGS. 1A and 1B show an example finance platform 100, according to some embodiments. At 1 and 2, stable coin loaner 240 is configured to loan to a user (e.g., as accessing finance platform 100 via a user account) an amount of stable coin (e.g., 1 BUSD less a fee) in exchange for a corresponding amount of token each valued at the floor price. Stable coin loaner 240 is configured to track the floor price and value of token relative to stable coin and can use same to authorize the loan transaction. Stable coin loaner 240 is configured to update an attribute(s) to represent the ownership or possession of stable coin loaned from the treasury to the user, as well as do so for tokens, according to some embodiments. For greater clarity, in some embodiments, an attribute is updated to represent what entity (e.g., user, treasury) has token and/or stable coin, where same came from, and where same is being transferred to. For example, each token or stable coin can be generic, with only quantities rather than specific identities being tracked. The tokens can be denoted as held in a token collateral treasury, for example. The stable coin issued to the user can be provided from a stable coin treasury, for example. An amount of stable coin can be withheld in the treasury in the amount of a fee levied for the transaction, for example. In some embodiments, a portion of the fee amount can be instead transferred to another user (e.g., referral) and/or used to buyback token from one or more other users or from token treasury directly via a coin offering. In the latter case, token is purchased from token treasury and the token is returned to the token treasury in a single transaction, where the stable coin proceeds are directed to the stable coin treasury, and this can increase the floor price. In the former case, where buyback is from a user, the user(s) receive the stable coin, and the token purchased is directed to token treasury, out of circulation. In the example shown, at 3, the fee is transferred to another entity. For example, the entity can be represented by an address controlled by developers or administrative users. The platform can be configured, in some embodiments, to direct proceeds (e.g., fees) to this entity or entities. For example, such proceeds can include a 2% fee levied on purchasers of token and a 0.5% fee levied as a loan processing fee or loan renewal fee. The proceeds can be in stable coin currency. The wallet of this address can benefit the holders of the address, rather than the entire community of users on the blockchain. Fee, interest, and exchange amounts other than those shown can be used in other examples, according to some embodiments.

In some embodiments, only a portion of a trading license fee is rewarded to a user(s). Exchange fees levied on the seller of token are removed from circulation by token regulator 230 and the exchange fees levied on the buyer go to a designated account (e.g., a company account controlled by the developers or administrative users). Interest fees and transfer fees (transfer fees such as to send token from Alice to Bob by Bob's wallet address, not part of the exchange process) are charged by token regulator 230 in token as a percentage and removed from circulation and directed to the token treasury exclusively, in some embodiments.

At 4, stable coin loaner 240 is configured to receive stable coin payments (e.g., on the loan's principal) and store same in a stable coin treasury. A portion of the payment can be transferred as a processing fee to another entity or processed as described similarly to other fees.

In some embodiments, stable coin loaner 240 is configured to transfer an amount of token held as collateral as interest, removing same from circulation, such as by transferring same into a token treasury.

In some embodiments, only fees in token currency are taken out of circulation. Fees that are charged in stable coin (e.g., a 2% exchange fee to buyers and 0.5% of a loan principal on issuance and renewal to loan takers) are directed to an entity address (e.g., a company controlled wallet) and are not removed from circulation.

In some embodiments, principal payments of a loan are repaid to a stable coin treasury. Stable coin does leave the stable coin treasury when a loan is issued and stable coin is directed back to the stable coin treasury when the loan is repaid. Until a user defaults, stable coin is considered to be in circulation as is their token held in the token collateral treasury, according to some embodiments. Upon defaulting, the token held in respect of the defaulted loan in the token collateral treasury is sent to the token treasury and updates are made to represent that amount of token being out of circulation, as is the flow and possession of stable coin. For example, an update is made to represent that the corresponding amount (e.g., the amount loaned out) of stable coin is not coming back to the stable coin treasury. For example, the stable coin treasury value is determined as (stable coin in the stable coin treasury+stable coin loaned out), which is used to determine the floor price as well as all token in circulation being (free token+collateralized token).

As shown, in some embodiments, treasury smart contract manager 210 is configured to sell tokens to a user in exchange for stable coin. A user may also buy token from other users in exchange for stable coin, as managed by exchange smart contract manager 220. Finance platform 100 is configured to present, such as at a user interface 250, user interface components depicting coin offerings and/or user offerings to sell token, the particulars of which are configured by exchange smart contract manager 220 and/or treasury smart contract manager 210, the latter such as with reference to the floor price and the number of tokens to be sold in the coin offering and the amount by which the floor price is to be increased following all the sale of all of the tokens in that coin offering. A user can view, evaluate particulars of same, and/or select one or more offerings so as to request and/or initiate a transaction. Finance platform 100 is configured to execute one or more transactions and update associate ownership/possession attributes relating to stable coin and/or token. Finance platform 100 is configured to collect a transaction fee, such as in stable coin currency, and transfer same to an entity. For example, in some embodiments, a portion of the proceeds of a transaction (e.g., 2%) is directed to an entity such as a company- or developer-controlled wallet, with the balance (e.g., 98%) directed to the seller of token. If the seller is the token treasury (i.e., transaction via a coin offering), the recipient of the balance is the stable coin treasury, as directed by stable coin treasury smart contract and managed by treasury smart contract manager 210. In some embodiments, the fee is instead processed as described herein, e.g., in a buyback, out of circulation, to another user (e.g., community reward). If the transaction is processed as part of a coin offering, treasury smart contract manager 210 is configured to collect stable coin from the user in the transaction (in some embodiments, less fees or other amounts) and store same in the stable coin treasury. This process can be used to regulate the floor price. Stable coin in the treasury is attributed as being held by all holders of token in circulation, pro-rata, for example, according to some embodiments. Each user can either sell or loan from their attributed stable coin in the stable coin treasury, according to some embodiments.

In some embodiments, in a buyback, buyback smart contract is configured to purchase token out of circulation from a coin offering (from token treasury) or from a user.

As shown, in some embodiments, token regulator 230 is configured to buy tokens from a user in exchange for stable coin. A user may also sell tokens from other users in exchange for stable coin. Finance platform 100 is configured to present, such as at a user interface 250, such offerings for sale and/or purchase. A user can view, evaluate particulars of same, and/or select one or more offerings so as to request and/or initiate a transaction. Finance platform 100 is configured to execute one or more transactions and update associate ownership/possession attributes relating to stable coin and/or token. Finance platform 100 at token regulator 230 is configured to collect a transaction fee, such as in stable coin currency, and transfer same to an entity. In some embodiments, the fee is instead processed as described herein, e.g., in a buyback, out of circulation, to another user (e.g., community reward). If the transaction is processed as a finance platform 100 buyback from the user, token regulator 230 is configured to remove token(s) collected from the user in the transaction (in some embodiments, less fees or other amounts) from circulation and store same in the token treasury.

As shown, in some embodiments, tokens can be manually purchased. For example, tokens can be manually purchased via the exchange smart contract or directly from the token treasury via the treasury smart contract. For example, in some embodiments, in a mobile application implementation of finance platform 100, this can be displayed in one place for convenience. The exchange smart contract is a P2P exchange that has offers in the form of ads and users who can respond to those ads. This can be referred to as offers or offerings.

As shown, membership fees can be collected in stable coin currency from users, and the stable coin so collected and stored in the stable coin treasury. In some embodiments, a token membership smart contract is configured to whitelist user wallet addresses and allows them to buy, sell, send, and receive token. When a user pays the trading license fee (this fee payment allows a user to use the exchange, which is to use the user exchange and to buy from the token treasury or to sell to the stable coin treasury, such as managed by the respective smart contracts), the proceeds of the fee is directed to the token membership smart contract and is divided to the respective user(s) in the referral chain, with a portion (e.g., 10%). allocated for use by the buyback smart contract. The token membership smart contract is configured to fund the buyback smart contract the 10% to use to purchase token, according to some embodiments. The buyback smart contract is configured to purchase the token and the token is taken out of circulation to the token treasury. The stable coin is directed to the stable coin treasury and can increase the floor price. The stable coins are part of the floor price regulation. Stable coin in the stable coin treasury can be loaned out, pro-rated to every user's token holdings.

Various embodiments have been described in detail. Changes in and or additions to the foregoing description may be made, and embodiments are not to be limited to those details. Section headings herein are provided as organizational cues. These headings shall not limit or characterize the embodiments.

What is claimed is:

1. A system for a finance platform, the system comprising:
at least one stored data structure defining:
one or more treasury smart contracts configured to:
sell, via at least one coin offering, at least a portion of a token not in circulation at a pre-determined price;
store at least a portion of a stable coin in a treasury, each portion of stable coin received from sale of the at least a portion of token not in circulation via the at least one coin offering; and
remove at least a portion of token from the circulation to regulate a floor price of each token, the floor price being:
(total stable coin stored in the treasury+total stable coin loaned)/(total token in the circulation); and
at least one processor configured to execute at least one of: the one or more treasury smart contracts, the one or more exchange smart contracts, or both.

2. The system of claim 1, the pre-determined price being twice the floor price and a number of tokens sold being set to increase the floor price by a pre-determined amount.

3. The system of claim 2, the pre-determined amount being 1%.

4. The system of claim 1, the system further comprising a token regulator configured to remove at least a portion of token from the circulation by charging at least one fee in token currency.

5. The system of claim 4, each fee comprising a loan fee, a transfer fee, an exchange fee, or any combination thereof.

6. The system of claim 1, the system further comprising a stable coin loaner configured to:
loan at least a portion of the stable coin from the treasury in exchange for at least a portion of token each at the floor price as a token collateral; and
if a loan is in default, remove at least a portion of token collateral from the circulation.

7. The system of claim 1, each stored data structure stored on a blockchain network.

8. The system of claim 1, the one or more treasury smart contracts configured to remove token from the circulation by purchase.

9. The system of claim 1, the at least one stored data structure defining one or more exchange smart contracts configured to manage token transactions between two or more users.

10. The system of claim 1, the system further comprising a token regulator configured to charging a trading license fee in stable coin currency and issue a portion of the trading license fee to a user and remove token from circulation by purchasing token using a second portion of the fee.

11. A computer-implemented method for regulating a finance platform on a blockchain network, comprising:
selling, via at least one coin offering, at least a portion of token not in the circulation at a pre-determined price;
storing at least a portion of a stable coin in a treasury, each portion of stable coin received from sale of the at least a portion of token not in circulation via the at least one coin offering; and
removing at least a portion of token from the circulation to regulate a floor price of each token, the floor price being:
(total stable coin stored in the treasury+total stable coin loaned)/(total token in the circulation).

12. The computer-implemented method of claim 11, the pre-determined price being twice the floor price and a number of tokens sold being set to increase the floor price by a pre-determined amount.

13. The computer-implemented method of claim 12, the pre-determined amount being 1%.

14. The computer-implemented method of claim 11, the method further comprising removing at least a portion of token from the circulation by charging at least one fee in token currency.

15. The computer-implemented method of claim 14, each fee comprising a loan fee, a transfer fee, an exchange fee, or any combination thereof.

16. The computer-implemented method of claim 11, the method further comprising loaning at least a portion of the stable coin from the treasury in exchange for at least a portion of token each at the floor price as a token collateral; and if a loan is in default, removing at least a portion of token collateral from the circulation.

17. The computer-implemented method of claim 11, the one or more treasury smart contracts configured to remove token from the circulation by purchase.

18. The computer-implemented method of claim 11, the at least one stored data structure defining one or more exchange smart contracts configured to manage token transactions between two or more users.

19. The computer-implemented method of claim 11, the method further comprising charging a trading license fee in stable coin currency and issuing a portion of the trading license fee to a user and removing token from circulation by purchasing token using a second portion of the fee.

20. A non-transitory computer-readable medium storing a set of machine-interpretable instructions, which, when executed, cause a processor to perform a method for regulating a finance platform, the method comprising:
selling, via at least one coin offering, at least a portion of token not in the circulation at a pre-determined price;
storing at least a portion of a stable coin in a treasury, each portion of stable coin received from sale of the at least a portion of token not in circulation via the at least one coin offering; and
removing at least a portion of token from the circulation to regulate a floor price of each token, the floor price being:
(total stable coin stored in the treasury+total stable coin loaned)/(total token in the circulation).
